(19) United States
(12) Patent Application Publication
(10) Pub. No.: US 2012/0262633 A1
(43) Pub. Date: Oct. 18, 2012

(54) LIGHTING DEVICE, DISPLAY DEVICE AND TELEVISION RECEIVER

(75) Inventors: Takehisa Yoshida, Osaka-shi (JP); Tomofumi Osaki, Osaka-shi (JP); Tomohiro Kosaka, Osaka-shi (JP); Atsushi Ban, Osaka-shi (JP)

(73) Assignee: SHARP KABUSHIKI KAISHA, Osaka-shi, Osaka (JP)

(21) Appl. No.: 13/515,874

(22) PCT Filed: Dec. 1, 2010
(86) PCT No.: PCT/JP2010/071443

§ 371 Date: Jul. 3, 2012

(30) Foreign Application Priority Data
Dec. 18, 2009 (JP) 2009-287577

(51) Int. Cl. H04N 3/14; F21V 13/02; G02F 1/13357; F21V 8/00

(52) U.S. Cl. 348/790; 362/611; 362/606; 362/613; 362/612; 349/65; 348/E03.016

(57) ABSTRACT

An object is to provide a lighting device with improved workability in assembling a light guide plate, a display device and a television receiver using this lighting device. The lighting device according to the present invention has LEDs 16, an inclined surface 32A to which light from the LEDs 16 enter, a light exit surface 31 which emits the light, and a light guide plate 30 with the light exit surface having a rectangular shape in a planar view. The light guide plate 30 has the inclined surfaces 32A and 32B inclined in a form protruding outside the light guide plate 30 in one direction of the light exit surface 31, as both side surfaces in the one side direction of the light exit surface 31 get closer to the side of the light exit surface 31. The inclined surfaces 32A and 32B on the both sides have symmetrical shapes with each other. One of the inclined surfaces 32A and 32B is a light entrance surface and is facing a luminous surface 16a of the LED 16.

### TECHNICAL FIELD

The present invention relates to a lighting device, a display device and a television receiver.

### BACKGROUND ART

In recent years, a thin-type display device, such as a liquid crystal panel or a plasma display panel, is used as a display device for an image display device. This usage enables the thin image display device. When the liquid crystal panel is used as the display device, the liquid crystal panel does not emit light itself. Therefore, a lighting device (backlight unit) is separately required.

A known example of the lighting device is disclosed in Patent Document 1. This lighting device includes LEDs (light sources) and light guide plates. The LEDs are arranged on the side edge of the lighting device. The light guide plates cause light from the LEDs to be emitted toward the display surface of the liquid crystal panel. More specifically, the LEDs are arranged toward the light entrance surface of the light guide plates. The light entered from a light entrance surface is guided by repeatedly being totally reflected in the light guide plate, and is emitted from a light exit surface.
Patent Document 1: Japanese Unexamined Patent Publication

### Problem to be Solved by the Invention

In the above-described lighting device of Patent Document 1, when the light guide plates are mounted, the light exit surface needs to be arranged in a predetermined direction (for example, on the side of the liquid crystal panel). Thus, the light guide plates need to be mounted with attention to the orientation of the light exit surface of the light guide plates, thus leaving room for improvement.

In a known lighting device, a plurality of light guide plates is arranged in matrix. Alight source is arranged for each light guide plate, and each light source is independently controlled to be driven. Then, brightness of light from each light guide plate can be controlled. As a result, on the light exit surface of the lighting device, brightness can be controlled for each area corresponding to each light guide plate, thus acquiring a high display quality (so-called a local dimming technique).

In the configuration including the plurality of light guide plates arranged as described above, a light source may be arranged between adjacent light guide plates. In this configuration, to keep the area for arranging the light source, a space may be generated between the adjacent light guide plates. Thus, a dark section is generated in a position corresponding to this space, and the uniformity of light decreases, thus causing uneven brightness. As a result that the plurality of light guide plates is arranged in matrix, the total number of light guide plates to be used increases, and the workability in assembling the light guide plates is decreased.

### DISCLOSURE OF THE PRESENT INVENTION

The present invention was made in view of the foregoing circumstances. An object of the present invention is to provide a lighting device with improved workability in assembling light guide plates. Another object thereof is to provide a display device and a television receiver, which include this lighting device.

### Means for Solving the Problem

To solve the above problems, according to the present invention, there is provided a lighting device including: alight source; and a light guide plate having a light entrance surface through which light from the light source enters and a light exit surface through which the light exits, the light exit surface having a rectangular shape in a planar view. The light guide plate has side surfaces at ends of one of sides thereof, the side surfaces being configured as inclined surfaces that are inclined toward the light exit surface of the light guide plate such that an end of the inclined surface on the light exit surface side is outer than another end of the inclined surface, and one of the inclined surfaces is configured as the light entrance surface that faces a light emitting surface of the light source.

The light entrance surface needs to be arranged toward a side of the emitting surface of the light source in order to make the light from the light source enter the light guide plate. The light exit surface needs to be arranged toward this predetermined direction in order to emit light from the light guide plate toward the predetermined direction. That is, when the lighting device is assembled, the direction of the light guide plate with respect to the light source needs to be aligned with the predetermined direction.

In the present invention, of side surfaces of the light guide plate, two side surfaces are inclined. The inclined surfaces are inclined toward the light exit surface of the light guide plate in one side direction of the light exit surfaces, as getting closer to the side of the light exit surface. Accordingly, in the light guide plate, the light exit surface and the surface opposite to the exit surface have different sizes, thus resulting easy distinguishing between both surfaces, as compared to a configuration where the light exit surface and its opposite surface have the same size (for example, the light guide plate has a rectangular parallelepiped shape). This results in preferable workability in arranging the light exit surface toward a predetermined direction.

The inclined surfaces on the both sides may have symmetrical shapes with other. In this configuration, the same optical characteristic can be obtained (for example, refraction of the light at the light entrance surface), when whichever surface of the both inclined surfaces is used as the light entrance surface. That is, when the light guide plate is arranged, either one of the two inclined surfaces may be arranged toward the light source. This realizes an easy operation for setting the direction of the light guide plate with respect to the light source, as compared to a configuration where only one surface of the light guide plate is selected and arranged toward the light source.

In the above configuration, the lighting device may further include a transmission scattering member configured to transmit and scatter light in the light guide plate such that the light exits from the light exit surface, and the transmission scattering member being arranged with lower distribution density in an area of the light exit surface closer to the end of one of sides on the light source side than in an area of the light exit surface around a center with respect to the one of sides.

According to this configuration, the light in the light guide plate can be emitted from the light exit surface by the transmission scattering member. According to the present invention, when the light entrance surface is inclined in a form protruding outside the light guide plate (side of the light source) in one side direction of the light exit surface, as getting closer to the light exit surface side, the light entered the light entrance surface is easily refracted toward the light exit surface. As a result, on the end part of the light exit surface on the light source side (light entrance surface where light enters), light tends to have a small incidence angle with respect to the light exit surface, thereby increasing the amount of light not totally reflected (light to be emitted). Thus, it can be assumed that a large amount of light is emitted on the end part of the light source side.

In the present invention, the transmission scattering member being arranged with lower distribution density in an area of the light exit surface closer to the end of one of sides on the light source side than in an area of the light exit surface around a center with respect to the one of sides. By this setting, it is possible to lower an amount of light exit on the end part on the light source side of the light exit surface. Even when light is made incidence on the inclined light incidence of the present invention, an amount of light emitted on the end part of the light source side is prevented from being higher than that on the center. This can prevent uneven brightness. According to the present invention, the distribution density on the end part of the light source side is simply lower than the distribution density on the center side. For example, the transmission scattering member may not be formed on the end part of the light source side, and may be formed only on the center side.

The transmission scattering member may be formed of a dot patterns. According to this configuration, an aspect (area, arrangement interval) of the dots is set, thus enabling to easily set the distribution density of the transmission scattering members.

The light guide plate may have an elongated shape extending in a direction intersecting the one side direction of sides of the light exit surface, and the light source may include a plurality of light sources arranged along the direction intersecting the one of sides of the light exit surface. According to this configuration, the plurality of light sources is individually turned on, thereby controlling the brightness distribution in a direction intersecting one side direction of the light exit surface. Further, for example, as compared to a configuration where a plurality of light guide plates is aligned in a direction intersecting one side direction of the light exit surface, the total number of light guide plates is decreased, thus resulting in preferable workability in the arrangement. It is to be noted that the “direction intersecting the one side direction of the light exit surface” may, for example, be the “direction along a plane direction of the light exit surface and intersecting the one side direction of the light exit surface”.

The lighting device may further include a chassis housing the light source and the light guide plate. The light source may include a plurality of light sources and the light guide plate may include light guide plates arranged along a bottom plate of the chassis. The light guide plates may be arranged such that the inclined surface of one of the adjacent light guide plates is opposite the inclined surface of the other one of the adjacent light guide plates. The light sources may be arranged in light source arrangement area between the inclined surface of the one of the adjacent light guide plates and the inclined surface of the other one of the adjacent light guide plates.

Accordingly, the light source is arranged in the light source arrangement area formed between the two adjacent light guide plates, of the plurality of light guide plates arranged along the bottom plate of the chassis. In this configuration of the lighting device, it is possible to have a small interval in a direction intersecting the surface (bottom surface) of the bottom plate of the chassis. That is, it is possible to realize a local dimming technique and also possible to realize the thin lighting device, by aligning the plurality of light guide plates.

This light source arrangement area is formed by making the inclined surface of one light guide plate face the inclined surface of the other light guide plate. According to this configuration, the light source arrangement area can have a smaller upper end side (side close to the light exit surface) than that, for example, in the configuration having the light source arrangement area formed between two parallel surfaces. That is, in a planar view, the interval of the light exit surface in both the light guide plates can be made smaller, thus preventing uneven brightness generated in the space between the light exit surfaces.

The lower end side (side far from the light exit surface) of the light source arrangement area is formed large. Thus, for example, it is easy to have a large light source arrangement area, as compared to a configuration where only one of two surfaces is inclined (two facing surfaces) forming the light source arrangement area. This prevents heat generated when the light source is turned on from being remained, and suppresses the temperature from being raised in the light source, thus enhancing the operational reliability.

If the light source arrangement area is formed between the inclined surfaces, the lower end side (side far from the light exit surface) of the light source arrangement area can be formed larger than that of a configuration where only one of two surface is inclined (two facing surfaces) forming the light source arrangement area. Therefore, the large light source arrangement area can be formed easily. Accordingly, it is possible to prevent heat generated when the light source is turned on from being remained in the light source arrangement area. This can suppress the temperature from being raised in the light source, and can enhance the operational reliability.

The lighting device may further include at least one diffuser plate covering the adjacent light guide plates from both sides of the light exit surface. Accordingly, in the lighting device, it is possible to obtain the even brightness between a position corresponding to the light exit surface of the light guide plate and a position between the light guide plates, and to prevent a dark section from being generated in a position between the light guide plates.

The light source may be a light emitting diode. The power consumption may be lowered by using the light emitting diode.

A light reflection member reflecting the light from the light source toward the light exit surface may cover a surface opposite to the light exit surface on the light guide plate. According to this configuration, the light emitted toward the reflection member can be reflected again toward the light exit surface by the light guide plate, thus enhancing the light use efficiency.

To solve the above problems, according to the present invention, there is provided a display device including: the above-described lighting device; and a display panel configured to provide display using light from the lighting device.

The display panel may, for example, be a liquid crystal panel. This display device, as a liquid crystal display device, may be applied to various usages, such as a television or a desktop screen of a personal computer, and is particularly preferable for a large screen.

To solve the above problems, the television receiver of the present invention may include the display device.

### Advantageous Effect of the Invention

According to the present invention, there are provided a lighting device with improved workability in assembling a light guide plate, or a thin lighting device configured to perform local dimming, and a display device and a television device using this lighting device.

### BRIEF DESCRIPTION OF THE DRAWINGS

FIG. 1 is an exploded perspective view showing a schematic configuration of a television receiver according to a first embodiment of the present invention;

FIG. 2 is an exploded perspective view showing a schematic configuration of a liquid crystal display device included in the television receiver of FIG. 1;

FIG. 3 is a plan view showing a configuration of a backlight unit included in the liquid crystal display device of FIG. 2;

FIG. 4 is an enlarged view showing an enlarged part of FIG. 3;

FIG. 5 is a cross sectional view showing a cross sectional configuration along a short side direction of the liquid crystal display device of FIG. 2 (a cross sectional view taken along a line A-A of FIG. 4);

FIG. 6 is a plan view showing alight exit surface of alight guide plate; and

FIG. 7 is an enlarged cross sectional view showing an enlarged part near an LED in FIG. 5.

### BEST MODE FOR CARRYING OUT THE INVENTION

### First Embodiment

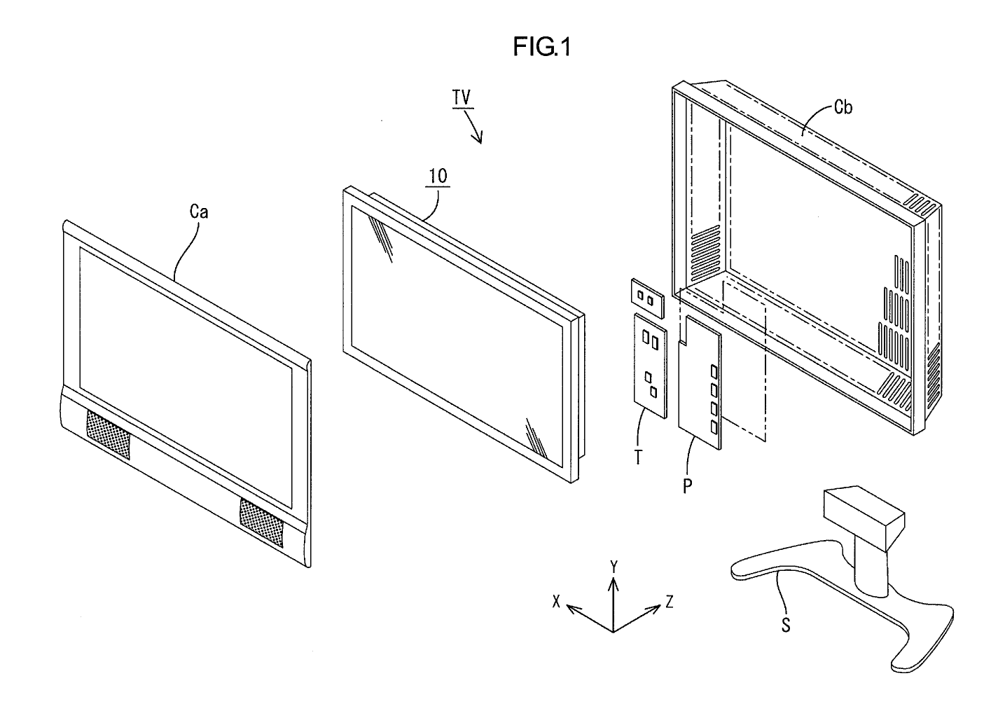

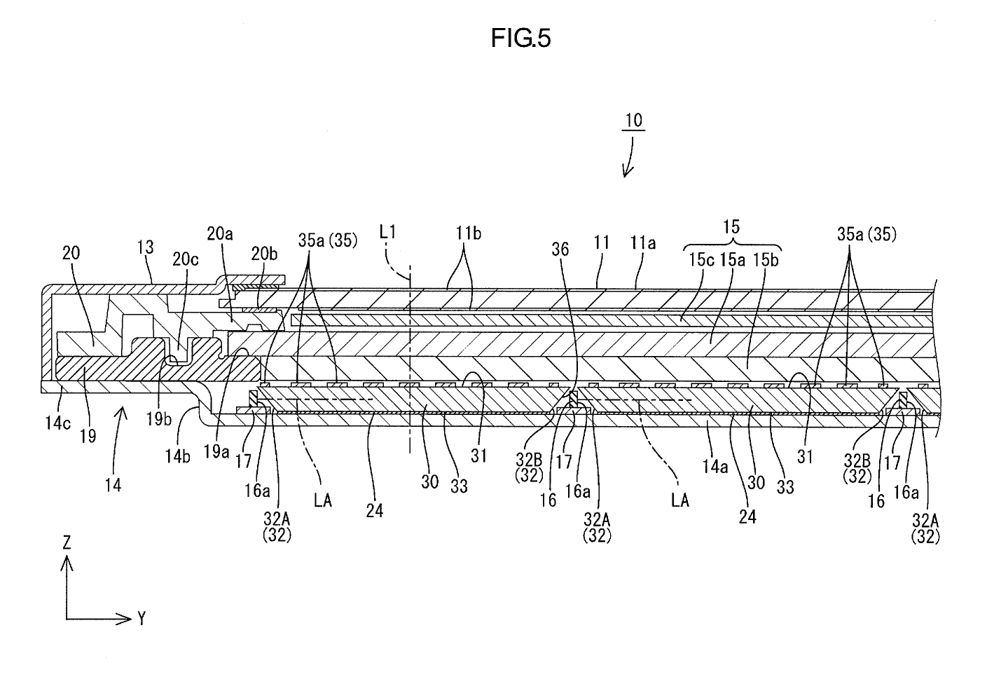

An embodiment of the present invention will be described with reference to FIGS. 1 to 7. In a part of each illustration, an X-axis, a Y-axis, and a Z-axis are shown. Each of the axial directions is common respectively among the illustrations. The upper side shown in FIG. 5 is the front side, while the lower side therein is the back side.

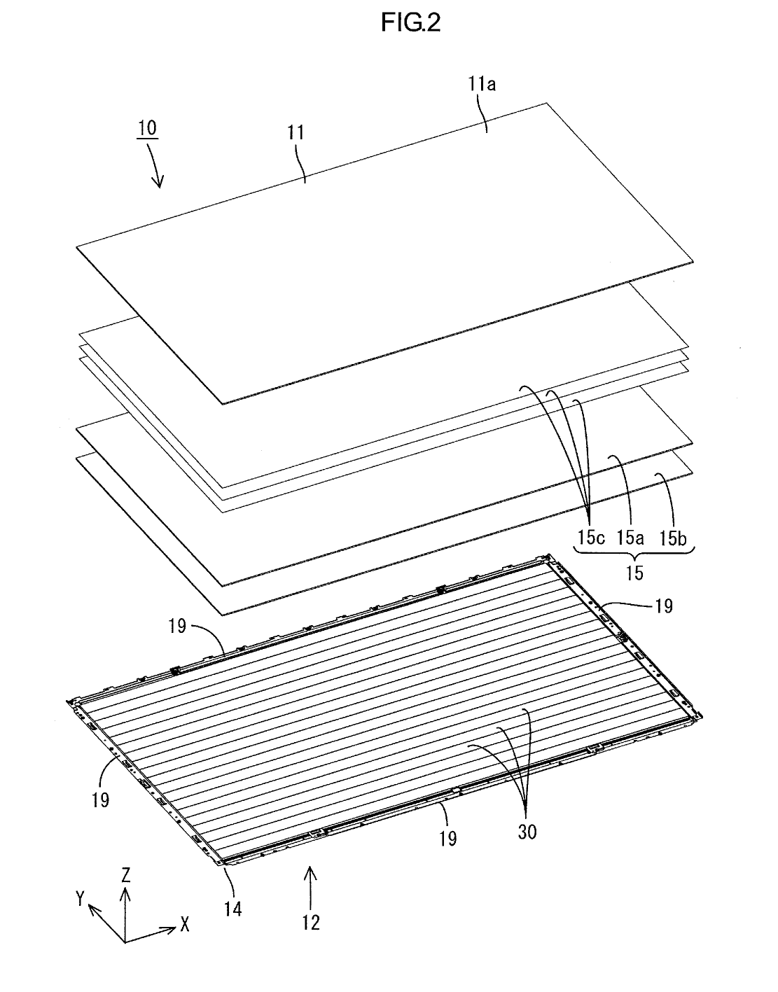

As shown in FIG. 1, a television receiver TV according to the present embodiment includes a liquid crystal display device 10 (display device), front and back cabinets Ca and Cb housing so as to sandwich the liquid crystal display device 10 therebetween, a power source P, and a tuner T. A display surface 11a is supported by a stand S, along a vertical direction (Y-axis direction), for example. The liquid crystal display device 10 has a horizontally long square shape as a whole. As shown in FIG. 2, the liquid crystal display device 10 includes a liquid crystal panel 11 as a display panel, and a backlight unit 12 (lighting device) as an external light source. The liquid crystal panel 11 and the backlight unit 12 are held integrally with a frame-shaped bezel 13 (see FIG. 5).

The liquid crystal panel 11 and the backlight unit 12 included in the liquid crystal display device 10 will be described in order. The liquid crystal panel 11 (display panel) has a rectangular shape in a planar view, and includes a pair of glass substrates bonded to each other with a predetermined gap therebetween and in which liquid crystals are enclosed. One glass substrate includes switching components (for example, TFTs) connected to source lines and gate lines that are orthogonal to each other, pixel electrodes connected to the switching components, alignment films, and the like. The other glass substrate includes color filters, counter electrodes, alignment films and the like. In the color filters, coloring sections such as R (red), G (green), B (blue) are arranged in a predetermined alignment. A polarizing plate 11b is formed on the outer surface of both electrodes (see FIG. 5).

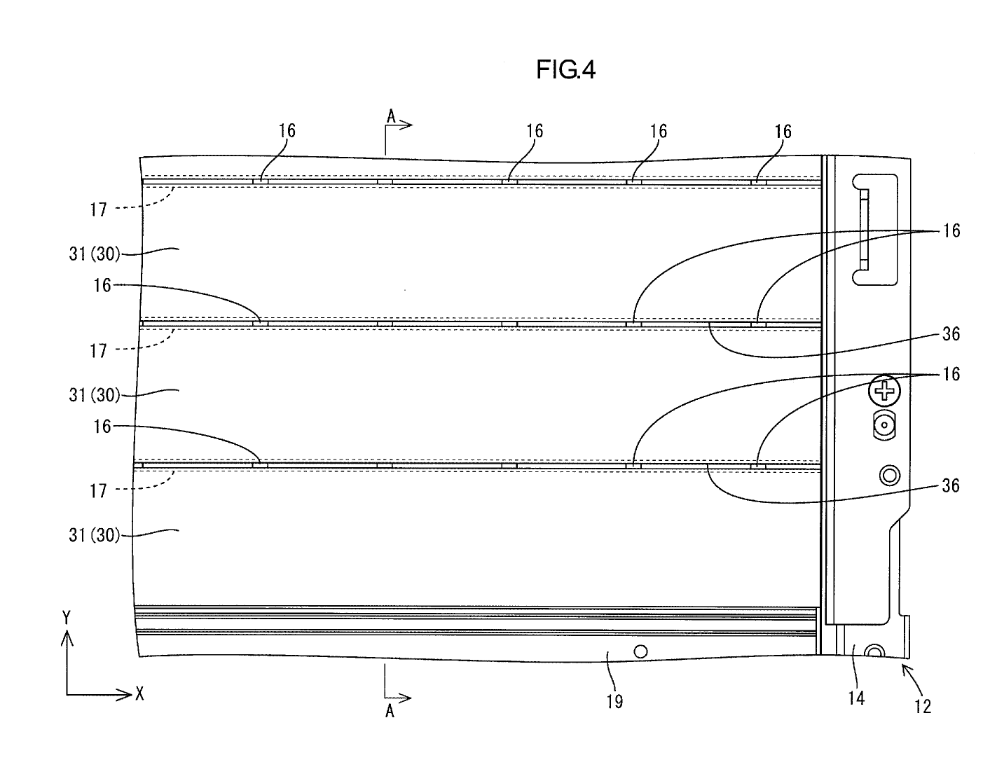

The backlight unit 12 will be described in detail. As shown in FIGS. 2 and 4, the backlight unit 12 includes a chassis 14, optical members 15, LEDs 16 (Light Emitting Diode), an LED board 17, and a light guide plate 30. The chassis 14 is formed in an approximately box-like shape having an opening toward the front side (on the side of the liquid crystal panel 11, the light exit side). The optical members 15 are arranged to cover the opening of the chassis 14. The LEDs 16 as light sources are arranged in the chassis 14. The LED board 17 has the LEDs 16 mounted thereon. The light guide plate 30 guides light emitted from the LEDs 16 to the optical members 15. As shown in FIG. 5, the backlight unit 12 includes a receiving member 19 and a holding member 20. The receiving member 19 receives diffuser plates 15a and 15b constituting the optical members 15 from the back side. The holding member 20 holds the diffuser plates 15a and 15b from the front side.

The chassis 14 is formed of metal, and as shown in FIG. 5, includes a bottom plate 14a, a side plate 14b, and a receiving plate 14c. The bottom plate 14a has a rectangular shape like the liquid crystal panel 11. The side plate 14b rises from the outer end of each side of the bottom plate 14a. The receiving plate 14c protrudes outward from the rising end of each side plate 14b. The chassis 14 is formed in an approximately shallow box-like shape (approximately shallow dish-like shape) opened toward the front side, as a whole. The chassis 14 has its long-side direction aligned with the horizontal direction (X-axis direction), and has its short side direction aligned with the vertical direction (Y-axis direction). On each receiving plate 14c of the chassis 14, the receiving member 19 or the holding member 20 can be mounted from the front side. On the receiving plate 14c, the bezel 13, the receiving member 19, and the holding member 20 are fixed with screws.

As shown in FIG. 5, the optical member 15 intervenes between the liquid crystal panel 11 and the light guide plate 30. The optical member 15 includes the diffuser plates 15a and 15b arranged on the side of the light guide plate 30 and the optical sheet 15c arranged on the side of the liquid crystal panel 11. The diffuser plates 15a and 15b are formed of a number of diffusing particles dispersed in a transparent resin base substrate with a predetermined thickness, and have a function of diffusing transmitted light. Two of the diffuser plates 15a and 15b have an equal thickness and are laminated on top of each other. The optical sheet 15c has a thickness thinner than those of the diffuser plates 15a and 15b, and three of the optical sheet 15c are laminated on top of each other. In the present embodiment, the optical sheet 15c is formed of three sheets such as a diffuser sheet, a lens sheet, and a reflection-type polarizing sheet in this order from the side of the diffuser plates 15a and 15b (back side). The configuration of the optical sheet 15c is not limited to the above, and may be changed appropriately. For example, of the diffuser sheet, the lens sheet, and the reflection-type polarizing sheet, only one of the sheets may be used, and the number of sheets to be used may possibly be changed.

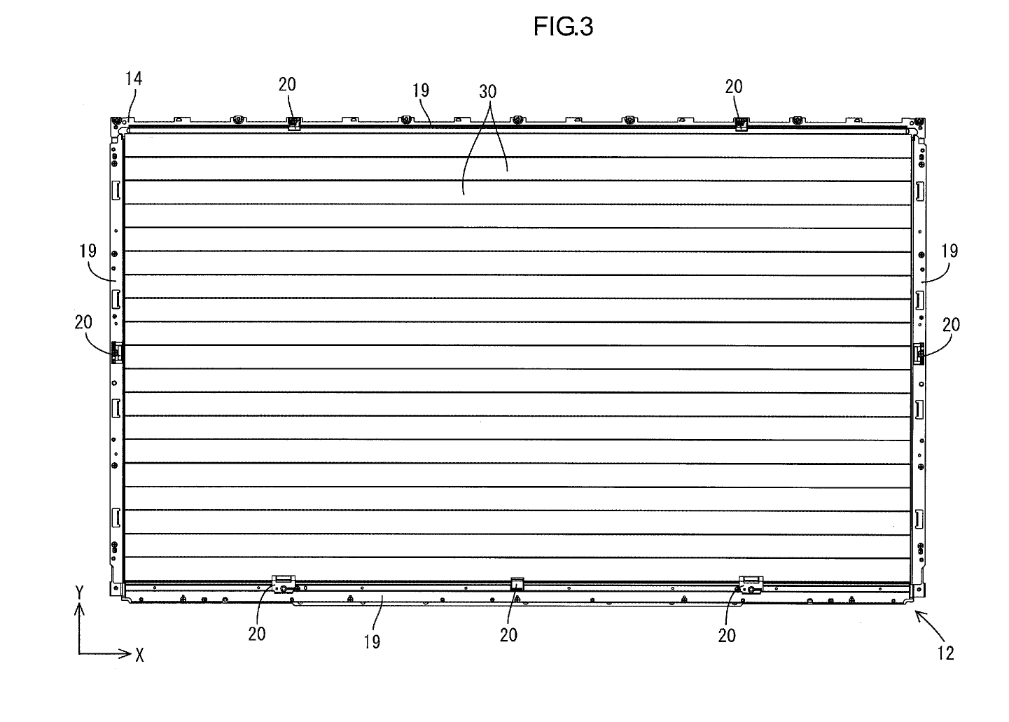

The receiving member 19 is arranged on the outer periphery end of the chassis 14, and configured to receive the outer periphery end of the diffuser plates 15a and 15b almost entirely. For example, as shown in FIG. 5, the diffuser plat 15a of the front side is provided on a step 19a formed on the inner end of the receiving member 19. As shown in FIG. 3, the holding member 20 is arranged on the outer periphery end of the chassis 14, and has a width sufficiently smaller than the short side of the chassis 14 or the diffuser plates 15a and 15b, thereby locally holding the outer periphery end of the diffuser plate 15a.

As shown in FIG. 5, the holding member 20 has a holding piece 20a extending into the chassis 14. The backside surface of this holding piece 20a is configured to hold the diffuser plate 15a, while the front side surface thereof is configured to receive the liquid crystal panel 11 through a buffer member 20b. The holding member 20 has a protrusion 20c configured to fit into a concavity 19b formed in the receiving member 19. The protrusion 20c fits into the concavity 19b, thereby positioning the holding member 20.

In the backlight unit 12 according to the present embodiment, the LEDs 16 are arranged on the side edge of each light guide plate 30. Configurations of the light guide plate 30 and the LED 16 will be described. The light guide plate 30 has a rectangular shape elongated in an X-axis direction in a planar view, as shown in FIGS. 3 and 4, and short side direction thereof is parallel to the short side direction (Y-axis direction, vertical direction) of the chassis 14, while the long side direction is parallel to the long side direction (X-axis direction, horizontal direction) of the chassis 14. The light guide plates 30 are aligned in a plurality of rows (nineteen rows in the present embodiment) in the Y-axis direction on the bottom plate 14a of the chassis 14. The light guide plates 30 are aligned in the Y-axis direction, where each of the LEDs 16 is arranged between the light guide plates 30 (light source arrangement areas 36) in a plurality of rows in the X-axis direction.

The LED 16 is surface-mounted on the LED board 17, as shown in FIGS. 4 and 5. The LED 16 has approximately a block shape as a whole, and is a side-surface light emission type device whose side surface adjacent to the mounted surface (bottom surface in contact with the LED board 17) on the LED board 17 is a luminous surface 16a. The LED 16 has a light axis LA arranged along the Y-axis direction. More specifically, the light axis LA of the LED 16 is arranged in a direction parallel to the display surface 11a of the liquid crystal panel 11 or a light exit surface 31 of the light guide plate 30. In other words, the light axis LA is aligned with the short side direction of the chassis 14 (direction along the bottom plate 14a of the chassis 14), that is, aligned with the vertical direction. The light emission direction (light emission direction from the luminous surface 16a) is oriented upward in the vertical direction.

The light emitted from the LED 16 spreads three-dimensionally in a radial pattern within a predetermined angle range at the center of the light axis LA, and its directivity is higher than, for example, a cold-cathode tube. That is, the LED 16 has an emission intensity indicating an angular distribution in which the intensity is remarkably high in a direction along the light axis LA, and in which the intensity dramatically decreases as the inclined angle with respect to the light axis LA increases.

The LED 16 includes a plurality of LED chips as light emitters that are sealed inside the housing a resin member. This LED 16 includes, for example, three kinds of LED chips with different dominant emission wavelengths. Specifically, the respective LED chips monochromatically emit lights of R (Red), G (Green), and B (Blue). The proximal side of the LED 16 is soldered onto a land of the LED board 17.

The LED board 17 is formed of a synthetic resin with a white front surface (including s surface facing the light guide plate 30) with excellent light reflectivity. As shown with a dashed line of FIG. 4, the LED board 17 has a rectangular plate shape extending in the X-axis direction in a planar view and a long side dimension thereof is substantially equal to a long side dimension of the bottom plate 14a. The bottom plate 14a has an installation hole (not shown) penetrating in a predetermined position therein to fix the LED board 17 with a screw.

The LED board 17 has a wiring pattern (not shown) formed of a metal film, and has a plurality of LEDs 16 mounted in predetermined positions. This LED board 17 is connected to a non-illustrative control board to receive electricity necessary for turning on the LEDs 16 therefrom, and is configured to control driving of the LEDs 16. The LED board 17 has the plurality of LEDs 16 provided thereon and aligned along the long side direction thereof. The LED board 17 has a photosensor (not shown) provided thereon as well as the LEDs 16. This photosensor detects an emission state of each LED 16, thus realizing feedback control of each of the LEDs 16.

As shown in FIG. 5, the light guide plate 30 has a symmetrical shape about an axis of symmetry L1 passing through the center position of the short side direction (Y-axis direction) as a whole, and has a trapezoidal shape in a cross sectional view. The light guide plate 30 is formed of substantially transparent (capable of excellent light transmission) synthetic resin materials (for example, polycarbonate) whose refraction index is sufficiently higher than air.

Of the surfaces of the light guide plate 30 facing the front side, that is, the substantially entire surface area facing the diffuser plate 15b is the light exit surface 31 having a rectangular shape (square shape) in a cross sectional view. The light exit surface 31 is substantially a smooth surface, and is about parallel to plate surfaces (or the display surface 11a of the liquid crystal panel 11) of the diffuser plates 15a and 15b. Of the side surfaces of the light guide plate 30, both side surfaces in one side direction (Y-axis direction) of the light exit surface 31 are inclined surfaces 32 oriented toward the LEDs 16.

The inclined surfaces 32 are inclined in a form protruding outside the light guide plate 30 in the Y-axis direction, as getting closer to the light exit surface 31. That is, on the light guide plate 30, the left inclined surface 32 (identified by a reference symbol 32A) shown in FIG. 5 is inclined in a form protruding toward the left side of FIG. 5, as getting closer to the light exit surface 31, while the right inclined surface 32 (identified by a reference symbol 32B) show in FIG. 5 is inclined in a form protruding toward the right side of FIG. 5, as getting closer to the light exit surface 31. Both of the inclined surfaces 32A and 32B are symmetrical (for example, they are symmetrical about the above-described axis of symmetry L1).

In the present embodiment, one of inclined surfaces 32 (the left inclined surface 32A of the light guide plate 30 in FIG. 5) is arranged to face the corresponding LED 16. More specifically, the inclined surface 32A is arranged to face the luminous surface 16a of the LED 16, and is a light incident surface to which light enters from the LED 16. That is, the light guide plate 30 of the present embodiment has two of the inclined surfaces 32 on both sides of the Y-axis direction, and light from the LED 16 enters from the one inclined surface 32A.

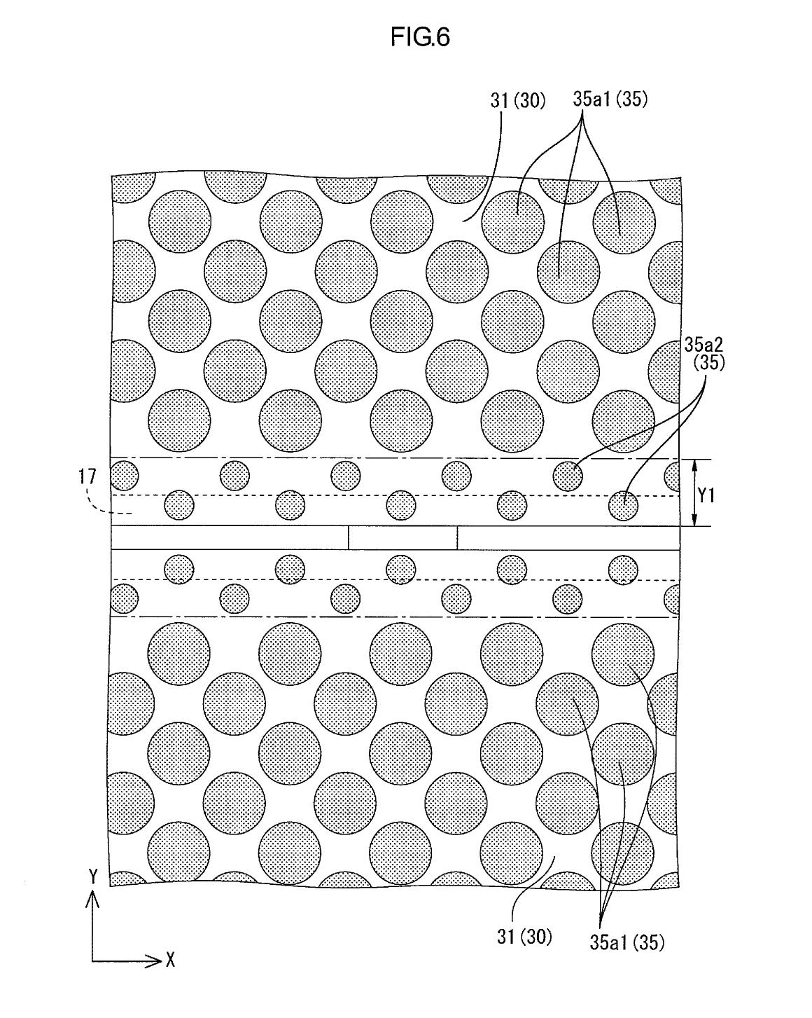

Transmission scattering units 35 transmitting and scattering light are formed on the nearly entire surface of the light exit surface 31. The transmission scattering units 35 are formed of a dot pattern. As shown in FIG. 6, for example, a plurality of dots 35a with around shape in a planar view is arranged in zigzags (stagger pattern, alternate pattern). The dots 35a are formed by printing paste containing transparent particles as transmission scattering materials (plastics or glasses) onto the light exit surface 31. This printing technique preferably includes silkscreen printing, ink jet printing and the like. The refraction index of such transparent particles is set substantially equal to the refraction index of, for example, the light guide plate 30. Light in the light guide plate 30 is scattered by the transmission scattering units 35. As a result, angle formed by light incident on the light exit surface 31 generates light not beyond the critical angle (light not totally reflected), and light can be emitted externally from the light exit surface 31.

In the present embodiment, as shown in FIG. 6, an area of each of the dots 35a (identified by a reference symbol 35a2 in FIG. 6) in the end part Y1 on the side of the LED 16 in the Y-axis direction is formed smaller than an area of the dots 35a (identified by a reference symbol 35a1 in FIG. 6) in the central portion in the Y-axis direction. In the Y-axis direction (one side direction of the light exit surface 31) of the light exit surface 31, the distribution density of the transmission scattering units 35 of the end part Y1 on the side of the LED 16 is set lower than the distribution density of the transmission scattering units 35 on the center side in the Y-axis direction.

The distribution density of the transmission scattering units 35 may be set as described above by appropriately setting the arrangement interval of the dots 35a, other than changing the areas of the dots 35a. The transmission scattering units 35 (dots 35a) may be formed only on the center side without being formed in the end part Y1. As a result, the distribution density of the transmission scattering units 35 of the end part Y1 (light source side end part) on the side of the LED 16 may be lower than the distribution density of the transmission scattering units 35 on the center side. The end part Y1 on the side of the LED 16 is not limited to the range shown in FIG. 6. Another configuration is applicable, as long as the distribution density of the transmission scattering units 35 is set relatively low on the side of the end part (outside) of the LED 16 side in the Y-axis direction, and the distribution density thereof on the center side in the Y-axis direction is set relatively high.

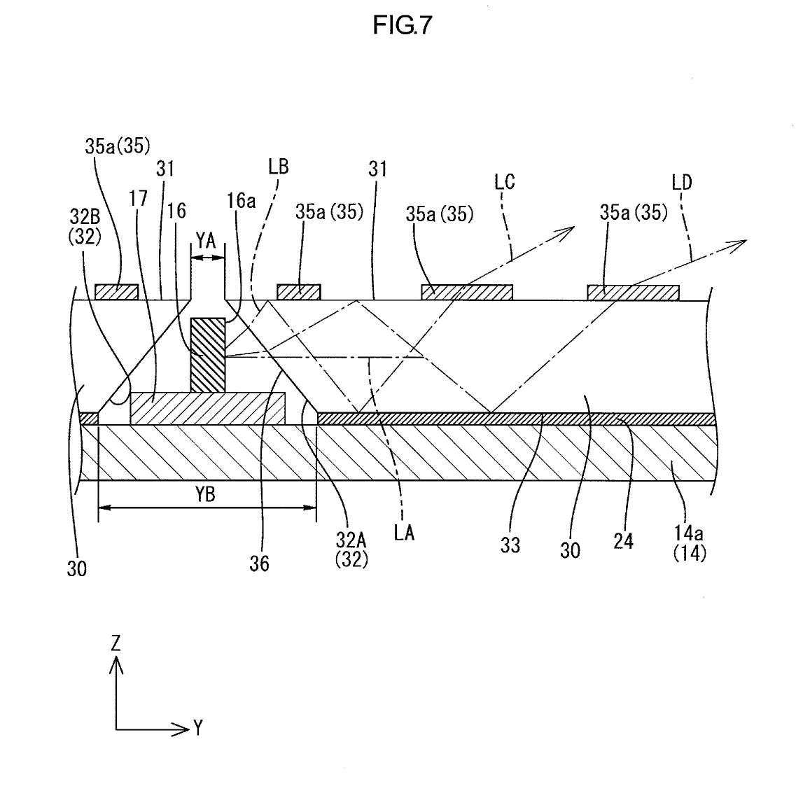

According to the above-described configuration, light entered from the inclined surface 32A (light incident surface) of the light guide plate 30 is totally reflected and guided in the light guide plate 30. Then, the light is scattered by the transmission scattering units 35 on the light exit surface 31, thereby being emitted from the light exit surface 31 (light emitted from the light exit surface 31 is identified by arrows LC and LD in FIG. 7). The light emitted from the light exit surface 31 is irradiated onto the back surface side of the liquid crystal panel 11.

The chassis 14 has a light reflection sheet 24 (reflection member) laid on the bottom plate 14a thereof. The light reflection sheet 24 covers nearly the entire backside surface (a surface 33 opposite to the light exit surface 31) of the light guide plate 30. The light reflection sheet 24 is formed of, for example, a synthetic resin with a white front surface with excellent light reflectivity. The reflection sheet 24 reflects light emitted thereon from the light guide plate 30 again onto the light exit surface 31, thus enabling to increase the light use efficiency. Note that the material, color or the like of the light reflection sheet 24 is not limited to the present embodiment, and any light reflection sheet is applicable as long as it reflects light.

As described above, a plurality of light guide plates 30 is aligned in the Y-axis direction along the bottom plate 14a of the chassis 14 (see FIG. 3). In the arrangement of the two adjacent light guide plates 30, the inclined surface 32 (for example, the inclined surface 32A in FIG. 5) of one light guide plate 30 is oriented to the inclined surface 32 (for example, the inclined surface 32B in FIG. 5) of the other light guide plate 30. This arrangement forms the light source arrangement area 36 in which the LED 16 is arranged between the adjacent inclined surfaces 32A and 32B.

As described above, the light guide plates 30 have a shape extending in the X-axis direction (direction intersecting the above-described one side direction (Y-axis direction) of the light exit surface 31). As shown in FIG. 4, the light source arrangement area 36 also has a shape extending in the X-axis direction in corresponding to the light guide plates 30. Along the extended direction (X-axis direction) of this light source arrangement area 36, the plurality of LEDs 16 is aligned. In other words, the plurality of LEDs 16 is aligned over nearly the entire length of the long side direction on the light guide plate 30. The extended direction of the light guide plate 30 is not limited to the X-axis direction, and may be any direction as long as it “intersects the one side direction of the light exit surface”. The above-described X-axis direction can be paraphrased as “a direction along a surface direction (X-axis and Y-axis directions) of the light exit surface and intersecting the one side direction of the light exit surface”.

As shown in FIG. 7, a length YB in the lower end part (end part of the back side) of the light source arrangement area 36 in the Y-axis direction is set larger than a length YA of the upper end part (end part of the surface side, end part close to the light exit surface 31). That is, the light source arrangement area 36 has a trapezoidal shape in a lateral view, and thus has its smallest part in the upper end part and has a larger part toward the backside thereof.

The above-described optical members 15 (the diffuser plates 15a and 15b) have an area sufficiently so as to cover the entire light guide plates 30 arranged on the chassis 14. The optical members 15 are configured to cover the entire light guide plates 30 at once from the light exit surface 31 side (front side). The covered area includes spaces between the adjacent light guide plates 30 (spaces between the light guide plates 30, areas corresponding to the upper end parts of the light source arrangement areas 36).

Functions and effects of the present embodiment will be described next. In a process of manufacturing the backlight unit 12, the light guide plates 30 are assembled to the LED boards 17 on which the LEDs 16 are surface-mounted. Specifically, after the LED boards 17 are set in predetermined positions of the bottom plate 14a of the chassis 14, the light guide plates 30 are mounted in positions corresponding to the respective LEDs 16 on the LED boards 17.

At this time, the inclined surface 32 needs to be arranged toward the light guide plate 30 in order to make light from the LED 16 enter the light guide plate 30. The light exit surface 31 needs to be arranged toward the liquid crystal panel 11 in order to emit light from the light guide plate 30 to the liquid crystal panel 11. That is, when the backlight unit 12 is assembled, the light guide plate 30 needs to be orientated appropriately with respect to the LED 16.

In the present embodiment, of the side surfaces of the light guide plate 30, two side surfaces are set as the inclined surfaces 32. The inclined surfaces 32 are inclined in a form protruding outside the light guide plate 30 in the Y-axis direction (one side direction of the light exit surface 31), as getting closer to the light exit surface 31. In this configuration, the light exit surfaces 31 and the surfaces 33 opposite to the light exit surfaces 31 have different sizes in the light guide plates 30. This results in easy distinguishing between both surfaces, as compared to a configuration where the light exit surfaces 31 and the surfaces 33 opposite to the light exit surfaces 31 have the same size (for example, a configuration where the light guide plates 30 have a rectangular parallelepiped shape). This realizes preferable workability in arranging the light exit surfaces 31 to be oriented toward a predetermined direction.

Further, both of the inclined surfaces 32A and 32B have symmetrical shapes with each other. Of the inclined surfaces 32A and 32B, whichever surface may be used as the light entrance surface, and the same optical characteristic can be generated between the both surfaces. When the light guide plate 30 is arranged, either one of the two inclined surfaces 32A and 32B may simply be arranged to face the luminous surface 16a of the LED 16 (in the present embodiment, the inclined surface 32A is facing the luminous surface 16a). This realizes easer workability in arranging the light guide plate to be oriented toward the LED 16, compared to a configuration where only one surface of the light guide plate 30 is selected and is arranged to be oriented toward the LED 16. The inclined surfaces 32A and 32B may have asymmetrical shapes with each other.

After the light guide plates 30 are installed onto the chassis 14 in an appropriate orientation, another member is assembled, thereby completing assembly of the backlight unit 12 and the liquid crystal display device 10. Accordingly, in the present embodiment, it is possible to improve the workability in assembling the light guide plate 30 onto the chassis 14. This enables to provide the backlight unit 12 with improved workability in assembling the light guide plates 30, the liquid crystal display device 10 including this backlight unit 12, and the television receiver TV.

The light exit surface 31 has the transmission scattering units 35 provided thereon. The units 35 transmit and scatter light in the light guide plate 30, thereby emitting the light from the light exit surface 31. The distribution density of the transmission scattering unit 35 on the end part on the side of the LED 16 in the Y-axis direction is lower than the distribution density of the transmission scattering unit 35 on the center in the Y-axis direction.

In the present embodiment, the inclined surface 32 is inclined in a form protruding outside (the side of the LED 16) the light guide plate 30 in the Y-axis direction, as getting closer to the light exit surface 31. Thus, as shown in FIG. 7, light entered the inclined surface 32A, which is a light entrance surface is likely to be refracted toward the light exit surface 31 (the refracted light is identified by an arrow LB). The amount of light having a small incidence angle with respect to the light exit surface 31 is increased at the end part on the side of the LED 16. As a result, on the light exit surface 31, the amount of light not totally reflected (light to be emitted) is increased. If the distribution density of the transmission scattering units 35 is equal over the entire surface of the light exit surface 31, an amount of light to be emitted is increased on the end part on the side of the LED 16. Hence, the end part of the light exit surface 31 on the LED 16 side is brighter than the center part, thus possibly resulting in uneven brightness.

In the present embodiment, the distribution density of the transmission scattering unit 35 on the end part on the side of the LED 16 in the Y-axis direction is lower than the distribution density of the transmission scattering unit 35 on the center side in the Y-axis direction. Thus, an amount of light to be emitted is decreased in a position with low density of the transmission scattering units 35 than an amount of light to be emitted in a position with high density thereof. Thus, an amount of light to be emitted is decreased on the end part of the light exit surface 31 on the side of the LED 16. Even when light enters the inclined surface 32 with the inclined form as described in this embodiment, it is possible to prevent a situation where an amount of light to be emitted is increased on the end part on the side of the LED 16 than an amount of light to be emitted on the center side, thus preventing uneven brightness.

The transmission scattering units 35 are formed of a dot pattern. In this configuration, an aspect (area, arrangement interval) of the dots 35a is set, thus enabling to easily set the distribution density of the transmission scattering units 35.

The light guide plate 30 has a shape extending in the X-axis direction (the direction intersecting one side direction of the light exit surface 31). The plurality of LEDs 16 is aligned in this light guide plate 30 in the X-axis direction. According to this configuration, the plurality of LEDs 16 aligned along the X-axis direction is individually turned on, thereby controlling the brightness distribution in the X-axis direction. Thus configured light guide plates 30 and the LEDs 16 are aligned in the Y-axis direction. In this configuration, a control board (not shown) controls whether or not each of the LEDs 16 is turned on, thereby enabling to control the brightness distribution in a planar direction (X-axis direction and Y-axis direction) on the light emission side of the backlight unit 12. This is so-called a local dimming technique. This enables to remarkably improve the contrast performance necessary in the display performance of the liquid crystal display device 10.

According to this configuration (a configuration including the light guide plates 30 extending in the X-axis direction and the LEDs 16 aligned in the same direction), a smaller number of components is used for the light guide plate 30 than a configuration with a plurality of light guide plates in the X-axis direction and LEDs 16 corresponding to the light guide plates 30, resulting in preferable workability in assembling.

The lighting device further includes the chassis 14 housing the LEDs 16 and the light guide plates 30. The plurality of LEDs 16 and light guide plates 30 are aligned along the bottom plate 14a of the chassis 14. Of two adjacent light guide plates 30, the inclined surface 32A of one light guide plate 30 is arranged to face the inclined surface 32B of the other light guide plate 30. The LED 16 is arranged in the light source arrangement area 36 formed between the inclined surface 32A of the one light guide plate 30 and the inclined surface 32B of the other light guide plate 30.

Accordingly, the LED 16 is arranged in the light source arrangement area 36 formed between two adjacent light guide plates 30 arranged along the bottom plate 14a of the chassis 14. Accordingly, in the backlight unit 12, the size of the Z-axis direction (the direction intersecting the surface (bottom surface) of the bottom plate 14a of the chassis 14) can be made small. That is, the plurality of light guide plates 30 are aligned, thereby realizing a local dimming technique and forming the thin backlight unit 12.

Further, the light source arrangement area 36 is formed by setting the inclined surface 32A of the one light guide plate 30 to face the inclined surface 32B of the other light guide plate 30. The upper end side (side near the light emission surface) of the light source arrangement area 36 is made smaller compared to a configuration where the light source arrangement area is formed between two surfaces parallel to each other. That is, in a planar view, the space (length YA of FIG. 7) between the light exit surfaces 31 of the adjacent light guide plates 30 is made small, thus preventing uneven brightness that may occur in the space between the light exit surfaces 31.

If the light source arrangement area 36 is formed between the inclined surfaces 32A and 32B, the lower end (corresponding to the length YB of FIG. 7) side (side far from the light exit surface 31) of the light source arrangement area 36 is easily made larger compared to a configuration where only one surface of two surfaces facing to each other is inclined, the surfaces constituting the light source arrangement area 36. As a result, the light source arrangement area 36 is easily made large, thus preventing remaining of heat generated when the LED 16 is turned on inside the light source arrangement area 36. This also prevents temperature from being raised in the LED 16, and enhances operational reliability.

The lighting device further includes the diffuser plates 15a and 15b covering the space between the two adjacent light guide plates 30 from the light exit surface 31. In the backlight unit 12, it is possible to have even brightness between the portion corresponding to the light exit surface 31 of the light guide plate 30 and the portion corresponding to the space between the light guide plates 30, and to prevent a dark section generated in the portion between the light guide plates 30.

A light source is the LED 16 (Light Emitting Diode). The LED is employed to make the power consumption lower.

The light reflection sheet 24 covers the surface 33 on the side opposite to the light reflection surface 31, and reflects light from the LED 16 onto the side of the light exit surface 31. With this configuration, the light emitted from the light guide plate 30 to the side of the light reflection sheet 24 is reflected again onto the light exit surface 31, thereby enhancing the light use efficiency.

### Other Embodiment

The present invention is not limited to the above embodiments described in the above description. The following embodiments may be included in the technical scope of the present invention, for example.

(1) In the above-described embodiment, the Y-axis direction (short side direction of the chassis 14) has been described as the “one side direction of the light exit surface” byway of example. However, the present invention is not limited to this. For example, the X-axis direction (long side direction of the chassis 14) may be the “one side direction of the light exit surface”. Alternately, an arbitrary direction in a planar view along the X-axis direction and the Y-axis direction may be applied.

(2) In the above-described embodiment, the transmission scattering units 35 are formed on the light exit surface 31 of the light guide plate 30. This enables light to be emitted from the light exit surface 31. However, the present invention is not limited to this configuration. For example, a scattering reflection unit reflecting and scattering light may be formed on the surface 33 on the side opposite to the light exit surface 31. The scattered and reflected light by this scattering reflection unit may be emitted from the light exit surface 31.

(3) In the above-described embodiment, the dot pattern is printed, thereby forming the transmission scattering units 35. However, the present invention is not limited to this. For example, the transmission scattering units 35 may simply transmit and scatter light, and the light exit surface 31 may have a concave-convex surface or a lens-like form.

(4) The number of LEDs 16 and light guide plates 30 to be aligned and the alignment direction are not limited to those of the above-described embodiment, and changes may be made thereto.

(5) In the above-described embodiment, the diffuser plates 15a and 15b cover the entire light guide plates 30 arranged on the chassis 14. However, the present invention is limited to this. For example, the diffuser plates 15a and 15b may cover only a space between the adjacent light guide plates 30 from the side of the light exit surface 31.

(6) In the above-described embodiment, three LED chips monochromatically emitting lights of R (Red), G (Green), and B (Blue) are combined together, thereby forming the LEDs 16. However, the present invention is not limited to this configuration. For example, the LED chip monochromatically emitting light of blue may be embedded, and may emit light of white color with a phosphor. It is possible to use any light source other than the LED.

(7) In the above embodiment, TFTs are used as switching components of the liquid crystal display device. However, the present invention is applicable to liquid crystal display devices using switching components other than the TFTs (for example, thin-film diodes (TFD)), and also applicable to liquid crystal display devices performing a black and white display other than liquid crystal display devices performing a color display.

(8) In the above-described embodiment, the liquid crystal display device using the liquid crystal panel 11 as a display panel has been described as one example. However, the present invention is also applicable to display devices using different kinds of display panels.

(9) In the above-described embodiment, the television receiver including a tuner has been described. However, the present invention is also applicable to display devices without a tuner.

### EXPLANATION OF SYMBOLS

10: Liquid crystal display device (Display device)
11: Liquid crystal panel (Display panel)
12: Backlight unit (Lighting device)
14: Chassis
14a: Bottom plate of Chassis
15a, 15b: Diffuser plate
16: LED (Light source, light emitting diode)
16a: Luminous surface
24: Light reflection sheet (Reflection member)
30: Light guide plate
31: Light exit surface
32: Inclined surface
32A: Inclined surface (Inclined surface opposite to luminous surface of light source (Light entrance surface), and inclined surface on one light guide plate)
32B: Inclined surface (Inclined surface of other light guide plate) 33: Surface opposite to light exit surface on light guide plate
35: Transmission scattering unit
36: Light source arrangement area
TV: Television receiver
Y1: End part of LED 16 (End part on light source side)

1. A lighting device comprising:
a light source; and
a light guide plate having a light entrance surface through which light from the light source enters and a light exit surface through which the light exits, the light exit surface having a rectangular shape in a planar view, wherein
the light guide plate has side surfaces at ends of one of sides thereof, the side surfaces being configured as inclined surfaces that are inclined toward the light exit surface of the light guide plate such that an end of the inclined surface on the light exit surface side is outer than another end of the inclined surface, and
one of the inclined surfaces is configured as the light entrance surface that faces a light emitting surface of the light source.

2. The lighting device according to claim 1, wherein
the inclined surfaces on the both sides have symmetrical shapes with each other.

3. The lighting device according to claim 1, further comprising a transmission scattering member configured to transmit and scatter light in the light guide plate such that the light exits from the light exit surface, the transmission scattering member being arranged with lower distribution density in an area of the light exit surface closer to the end of one of sides on the light source side than in an area of the light exit surface around a center with respect to the one of sides.

4. The lighting device according to claim 3, wherein the transmission scattering member are formed of dot patterns.

5. The lighting device according to claim 1, wherein
the light guide plate has an elongated shape extending in a direction intersecting the one of sides of the light exit surface, and
the light source includes a plurality of light sources arranged along the direction intersecting the one of sides of the light exit surface.

6. The lighting device according to claim 1, further comprising a chassis housing the light source and the light guide plate, wherein:
the light source includes a plurality of light sources and the light guide plate includes light guide plates arranged along a bottom plate of the chassis;
the light guide plates are arranged such that the inclined surface of one of the adjacent light guide plates is opposite the inclined surface of the other one of the adjacent light guide plates; and
the light sources are arranged in light source arrangement area between the inclined surface of the one of the adjacent light guide plates and the inclined surface of the other one of the adjacent light guide plates.

7. The lighting device according to claim 6, further comprising at least one diffuser plate covering the adjacent light guide plates from the light exit surface side.

8. The lighting device according to claim 1, wherein the light source is a light emitting diode.

9. The lighting device according to claim 1, wherein the light guide plate has a surface opposite from the light exit surface covered by a light reflection member reflecting the light from the light source toward the light exit surface.

10. A display device comprising:
the lighting device according to claim 1; and
a display panel configured to provide display using light from the lighting device.

11. The display device according to claim 10, wherein the display panel is a liquid crystal panel including liquid crystals.

12. A television receiver comprising the display device according to claim 10.
